(19) United States
(12) Patent Application Publication
(10) Pub. No.: US 2019/0259080 A1
(43) Pub. Date: Aug. 22, 2019

(54) BATTERY SELECTION AND FEEDBACK SYSTEM AND METHOD

(71) Applicant: Johnson Controls Technology Company, Auburn Hills, MI (US)

(72) Inventors: Dale A. Gospodarek, Kenosha, WI (US); Bradley A. Beers, Dorr, MI (US); Rodger W. Eich, Holland, MI (US); Grant E. Carmichael, Grand Rapids, MI (US)

(21) Appl. No.: 16/404,406

(22) Filed: May 6, 2019

Related U.S. Application Data
(63) Continuation of application No. 14/791,099, filed on Jul. 2, 2015, now abandoned.
Application No. 14/791,099 is a continuation of application No. 13/275,081, filed on Oct. 17, 2011, now abandoned.

(51) Int. Cl. G06Q 30/06; G07F 9/02

(52) U.S. Cl. CPC G06Q 30/0623; G06Q 30/0631; G07F 9/023; G06Q 30/0643

(57) ABSTRACT

A technique is provided for selection of a component for a vehicle, such as in a retail establishment. The technique is particularly suited for selection situations where a range of products may be available depending upon the particular vehicle, such as batteries, tires, and so forth. A series of displays are provided to users that may be accompanied by audio and/or video prompts and information. An image of the vehicle is displayed, as well as an image of recommended products, to enhance the confidence of the consumer in making the selection. Data related to use of the system interface may be collected to provide feedback to retail establishments, manufacturers, and others as to stock, order, manufacturing and other needs based upon customer information detected through use of the system.

### CROSS REFERENCE TO RELATED APPLICATIONS

This application is a continuation of U.S. patent application Ser. No. 14/791,099, entitled “BATTERY SELECTION AND FEEDBACK SYSTEM AND METHOD, filed Jul. 2, 2015, which is a continuation of U.S. patent application Ser. No. 13/275,081, entitled “BATTERY SELECTION AND FEEDBACK SYSTEM AND METHOD,” filed Oct. 17, 2011, which is hereby incorporated by reference in its entirety for all purposes.

### BACKGROUND

The invention relates generally to the field of vehicle and other consumer products, and to methods and systems for aiding consumers in selecting replacement parts, providing installation instructions and to methods and systems for providing vendor feedback that might assist in serving consumers with respect to such products.

A wide range of systems have been developed and are currently in use for many different products and markets. Such systems vary from simple posters and kiosks, to more interactive systems that can search inventories, compare products and prices, and so forth. Increasingly, these systems are available on-line, such that consumers and shoppers may identify products and offerings remotely without visiting a commercial (“brick and mortar”) vendor location. However, while such systems are effective for certain products that potential buyers might feel comfortable purchasing for direct shipment, consumers still prefer to purchase certain products personally, and are much more comfortable actually visiting a retail outlet and receiving counseling prior to purchase. In many cases, the very nature of the product is such that the in-store visit will always be preferred.

For example, products and parts for automotive vehicles are most often purchased from retailers or various types of garages or parts outlets. Due to the considerable range of makes and models of vehicle, the proper selection can pose real problems, particularly for the relatively uninformed consumer, but also for store personnel, who may not be familiar with all possible choices, or the differences between them. To accommodate such situations, various interactive tools have been developed, many of which are intended for in-store use, such as in a point-of-sale display. However, such systems may be difficult and unintuitive to use, adding some benefit, but leaving the consumer with little confidence in recommendations or suggestions that the systems may make.

Moreover, such systems may offer little value added for retail establishments. Customer confusion may, in fact, result in loss of sales, and require additional rather than reduced involvement of store personnel. The systems generally do not track usage such that the establishments do not benefit secondarily from their use by potential customers in terns of evaluation, customer interest, and so forth.

There is a need, therefore, for improved product selection tools that may provide customers with more reliable recommendations and counseling, and that afford insightful information for retail establishments based upon their use. There is a particular need for such systems in vehicle parts markets where many different choices are available, and navigation between them can be particularly confusing.

### SUMMARY

The present invention relates to a system for selection of a motor vehicle component. The system may include a point of sale interface configured to interactively provide a series of user viewable displays and audio prompts for selection of a product by identification of a vehicle in which the product is configured to function, at least one of the displays comprising an image of the product and at least one of the displays comprising an image of the vehicle. A processing component is coupled to the user interface and configured to receive user inputs via the user interface, and to provide the user viewable displays and audio prompts based upon the inputs. The interface may be part of a kiosk that is positioned in a retail space near the products that can be identified by the system.

In accordance with certain embodiment, the system may include a logging component configured to log data based upon usage of the interface by users, and an analysis component coupled to the logging component and configured to analyze usage of the interface and to provide analyze data representative of usage of the interface at a particular retailer location.

In certain particular embodiments, the system is designed to recommend vehicle batteries available for sale in the retail establishment in which the kiosk is positioned. The interface screens may provide depictions of the battery or batteries that may be recommended for the vehicle, as well as an image of the user's vehicle, such images providing enhanced comfort and confidence on the part of the user in the selection of the battery for the user's particular vehicle.

In accordance with other aspects, the invention offers a method for providing product recommendations to customers. The method may include, in an interactive user interface provided in an in-store kiosk, providing a series of user viewable displays for selection of a vehicle battery by identification of a vehicle in which the battery is configured to function, at least one of the displays comprising an image of the battery and at least one of the displays comprising an image of the vehicle. User inputs are received via the interface, and, via processing circuitry, one or more databases is consulted based upon the user inputs to select at least one recommended battery. The method further includes displaying information relating to the at least one recommended battery in a user viewable display on the interface.

### DRAWINGS

FIG. 1 is general representation of a point of sale system designed to provide recommendations and feedback, as well as other information to a consumer and to collect information based upon interactions of the consumer with the system;

FIG. 2 is a diagrammatical representation of certain of the functional components of a system of the type shown in FIG. 1;

FIG. 3 is a flow chart illustrating certain of the major components that may be navigated to and through in such a system;

FIG. 4 is a flow chart representing certain user-viewable displays for identifying a device, such as a vehicle, in which a product of interest may be used in a system of the type illustrated in the previous figures;

FIG. 5 is a further flow chart illustrating certain user-viewable displays for determining the right parts for use on a specific vehicle;

FIG. 6 is a flow chart illustrating progression through a series of exemplary user-viewable displays for identifying a device, such as a vehicle, and identifying a product for use in the device, such as a battery, as well as for obtaining information for purchasing, installation, and so forth;

FIGS. 7-22 are illustrations of exemplary user-viewable displays as might be included in an interactive system for providing product recommendations, information, and so forth to a consumer.

### DETAILED DESCRIPTION

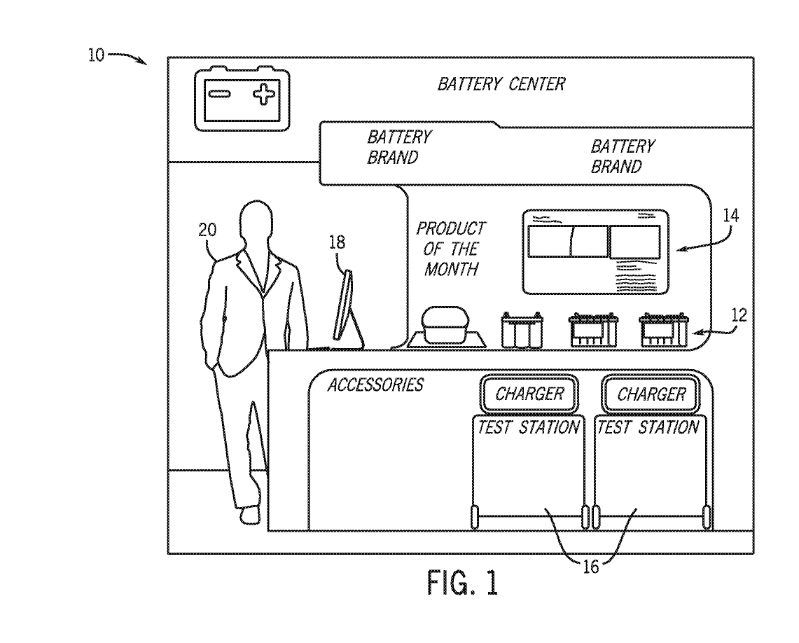

Turning now to the drawings, and referring first to FIG. 1, a point of sale installation 10 is illustrated generally. The installation may be provided in any of a range of locations, such as in a retain establishment that sells parts, products, and services to consumers. In the illustrated embodiment, the system is adapted for identifying and guiding consumers to vehicle parts, the selection of which may be extremely confusing without the system, or require wait times and investment in store personnel to counsel the consumers. Accordingly, the point of sale installation 10 may be provided in a retail store, in an auto parts outlet, and any other desired location. While many such parts and products may be the focus of the illustrated embodiment, in a presently contemplated implementation, the system is designed for the identification and selection of vehicle batteries. Many other products may be similarly recommended or identified by such systems, such as tires, engine parts, audio components, accessories, and so forth, both for vehicles and for other devices in which the products may function.

In the illustration of FIG. 1, the installation includes one or more product displays 12 in which actual products may be situated, or images of the products may be provided to facilitate identification by the consumers. Advertising information and literature may be provided as indicated by reference numeral 14, that provide further data on the products, guide consumers through the part selection and replacement process, and so forth. In the case of vehicle batteries, one or more chargers and/or test stations may be provided as indicated at reference numeral 16. These may allow users to at least partially charge or recharge existing batteries, new (purchased) batteries, to test old and new batteries, and so forth. An interactive user interface 18 is provided that allows a consumer 20 to interact with a computer system as described below. In presently contemplated embodiments, the interface 18 may comprise one or more computer screens, one or more hand-held devices, tablet computers and interfaces, and so forth. More than one such interface may be provided to accommodate multiple consumers simultaneously. The interface provides both visual and audio interaction that can effectively guide the consumer through product identification, selection, and even the purchase process.

The illustrated embodiment is particularly designed to function as a kiosk in a retail establishment or store. As such, the kiosk may be generally stand-alone, or may be coupled to one or more networks, including an internal network of the store, where desired. It may be positioned in or near a department where the searchable products are sold, and near which the users of the systems may locate the products once identified or selected. The kiosk, the software run on it, and the images provided may be specifically adapted to the store. Also, the embodiment illustrated is specifically designed for identifying and selecting vehicle batteries. It has been found that battery selection can be particularly confusing, and aspects of that process are facilitated by the interface screens and information provided to offer greater comfort and confidence for users, as described below.

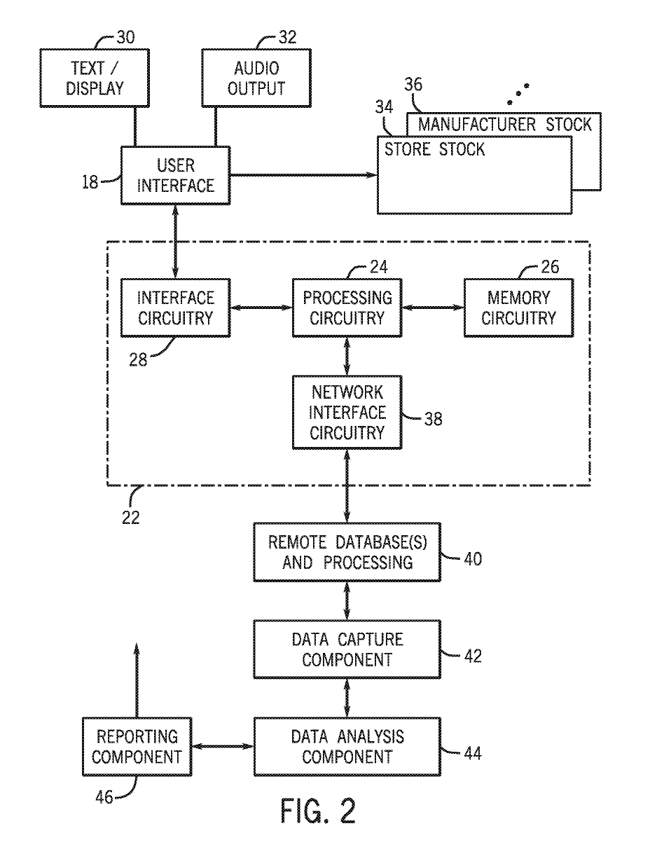

FIG. 2 illustrates certain functional components that may be included in an interactive product selection and tracking system of this type. In general, the product information and selection system 22 will include one or more processors as indicated by reference numeral 24. This processing may be performed in a conventional computer that may be a general purpose computer or one specifically adapted for this purpose. Moreover, as illustrated in FIG. 2, the processing circuitry may be provided locally within the interactive system, although it could be remote to the system. The processing circuitry will be associated with memory circuitry 26 such as random access memory, read only memory, optical and/or flash storage devices, and so forth. This memory circuitry serves to store configuration parameters for the system, as well as data for serving a number of user viewable displays or screens for viewing by the user. The memory circuitry also provides programming for the processing circuitry that allows for reproduction of sounds and various audio (and video) output, such as for prompting a user through the displays as a particular product or device is identified. In general, the processing and memory circuitry function to lead users through a series of displays, with or without audio support, to identify a device, such as a particular vehicle, and a product, such as a vehicle battery, that may be of interest for purchase.

Interface circuitry 28 is provided that may communicate with the processing circuitry to serve displays and audio output to the user interface 18, mentioned above with reference to FIG. 1. The user interface also allows for input by the user which is channeled through the interface circuitry 28 to the processing circuitry. Such inputs may be defined by clicking a conventional mouse, typing characters on a keyboard, touching specific regions of the user interface (e.g., a touch screen) or any other form of input. The user interface 18, then, produces displays in the form of text, images, and graphics, which are displayed as indicated at reference numeral 30. In a presently contemplated embodiment, audio output 32 may also be provided, such as through conventional speakers. The audio output, where provided, is coordinated with a visual display output to assist users in navigating through various displays, facilitating the device and product identification and selection process.

The system may interface with a range of external information sources. In the embodiment illustrated in FIG. 2, for example, the user interface may indicate to users specific references to stocks within a retail establishment, as indicated by reference numeral 34. For this purpose, the user interface may point the user to locations of specific stocks (e.g., floor stock), to locations of store personnel to aid with the stocks, and so forth. Moreover, the user interface may, in certain embodiments, facilitate searching manufacturer stocks as indicated at reference numeral 36, where the retail establishment does not currently have a product selected by the user through the interface. Information regarding these stocks may be provided to the system via various networks, including an internal network of the retail establishment. Where desired, this network may be extended through wide area networks, the Internet, and so forth to search for stocks in other retail establishments (e.g., in sister stores), in manufacture back stocks, or even in manufacturers anticipated production.

Still further, the system 22 may be coupled to a range of external devices, such as through the retailer network, through a cellular network, or through any other network interface. In the embodiment illustrated in FIG. 2, a network interface 38 is provided. This network interface may communicate, for example, with one or more remote databases and processing systems as indicated by reference numeral 40. Again, these may be present within the retail establishment, or may be completely remote to the retail establishment. Moreover, many retail establishments will have access to internal networks for checking stock in sister establishments, and so forth. Here again, the connection between the network circuitry 38 and the remote database and the processing capabilities 40 may be wired or wireless. The particular configuration of the network interface 38 will depend upon the particular form of connectivity provided (e.g., wired, wireless, any particular network protocol, etc.). Thus, the point of sale system may be powered locally, but with little or no need for separate network wiring.

Additional capabilities may be provided internal or external to the system 22. In the embodiment illustrated in FIG. 2, several such components are provided that greatly enhance the utility of the system to retail establishments. In particular, a data capture component 42 is provided that serves the purpose of logging certain (or all) interactions between users and the system. That is, such factors as times and durations of interaction may be logged. In the case of vehicles, vehicle types, makes, models, years and so forth may be logged. Demographic information, such as user profiles, vehicle usage profiles, and so forth may be similarly logged. The data capture component 42 may also log a number or frequency of recommendations of certain products. Again, this component may be included in the system 22, or may be remote to the system, in the retail establishment or elsewhere (e.g., in a third party that provides data analysis services to the establishment). A data analysis component 44 may be used in conjunction with the data capture component. This data analysis component may allow for compiling the captured or logged data to identify trends, commonalities between searches, commonalities between recommended components or parts, and so forth. This information may be highly valuable to retail establishments in the planning for stocks and orders, stocks at particular locations, and so forth. A reporting component 46 may be provided that takes at least a part of the analyzed data from the data analysis component and provides reports to the retail establishments, manufactures, or any other party in the distribution chain. Such reporting may be provided on conventional paper reports, or may be sent or stored in electronic formats, such as via spreadsheets, compiled reports, and so forth. Here again, the reports provided by the reporting component may greatly facilitate management of staffing, stocks, and so forth of the component parts in the retail establishment, as well as ordering of such parts, overstock in other locations, exchange of parts and components between retail establishments, evaluation of success rates in making sales of parts and components, and so forth.

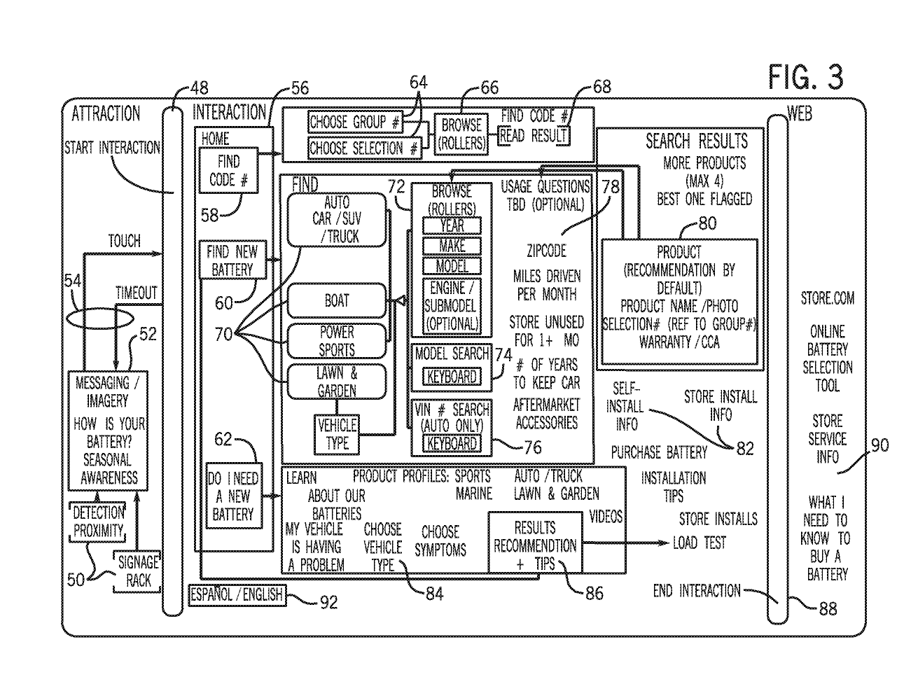

FIG. 3 illustrates an exemplary flow chart through various stages of information that may be presented to a user of an interactive product selection system of the type described above. The user experience may begin with a start stage 48 that may be preceded by certain attraction stages. In the illustrated embodiment, reference numeral 50 illustrates certain initiators that may lead into the display of an attraction 52. The initiators may comprise, for example, a signage rack that may be approached by the user, followed by proximity detection that indicates that user has approached the interactive system. Upon approach, the attraction 52 may be displayed, which may include images, graphics, textual invitations or questions, audio guidance, and so forth. Reference numeral 54 indicates certain interactive access between the user and the start stage. That is, the user may initiate the process by touching a screen or any other input device. The interaction may end, for example, by timing out, indicating, for example, that a user has moved away from the system.

Once the interactive stages have begun, various options may be provided, and these may be adapted for particular products, particular vendors, store locations, and so forth. For example, a home display 56 may be conveyed to the interface that provides one or more options selectable by the user. Again, the graphics, text, images, and audio prompts played during these various stages may be adapted for particular retail establishments, with logos, color patterns, or any other modifications as might be desired. In the illustrated embodiment, the system is adapted for selection of a battery for a motor vehicle. Accordingly, the home display 56 allows for input of battery code numbers as indicated by reference numeral 58, or entry into a “find” path as indicated by reference numeral 60, or various instructional and troubleshooting paths as indicated by reference numeral 62. Again following the illustrated embodiment, if the code selection 58 is selected, a series of displays and audio prompts may be played, such as to prompt a user to select a group number or a selection number as indicated by reference numeral 64, followed by graphics for selection of these numbers as indicated by reference numeral 66. In a presently contemplated embodiment, such graphics may include simulated rolling components, although various buttons, gesture inputs, and the like may be employed, depending upon the type of input device used, the input device capabilities, and the design of the system. Based upon the inputs provided by the user, then, a result may be searched and displayed to the user as indicated by reference numeral 68.

In the illustrated embodiment, if the “find” path is followed, the user may be prompted to select a vehicle type as indicated by reference numeral 70, such as an automobile, boat, power sports vehicle, lawn and garden vehicle or tool, and so forth. Based upon this selection, the user may then be prompted to select various parameters of the vehicle, such as of the year, make, model, engine, and the like as indicated by reference numeral 72. Of course, in certain embodiments, this information may simply be typed into the system, or otherwise input. Moreover, in the illustrated embodiment, a model search may be implemented as indicated at reference numeral 74, in which a keyboard is used to input model information. A further alternative illustrated comprises a VIN (vehicle identification number) search. Clearly, this and certain of the other searches may refer to data stored in the interactive system, or data that is accessed by the interactive system, such as through the retail institution network, wide area networks, the Internet, and so forth. Finally, in the illustrated embodiment, the system may prompt the user to input various usage data that may assist in the recommendation of a battery. Based upon these inputs, then, the system searches the one or more stored or available databases supporting the system for products that correspond to the inputs. In this case, a recommended battery is selected and information regarding the selection is displayed as indicated at reference numeral 80. Such information may identify the battery, as well as the availability of the battery, location of the battery in the store stock, product information relating to the battery, warranty information, and so forth. Moreover, if a battery is selected by the user, the user may also desire information on installation, such as indicated by reference numeral 82. This information may include, as described below, tips for installation, required tooling for installation, and so forth. Information may also be provided relating to the ability for the retail establishment to install a battery (or any other service offerings).

As described below, the use of graphics, images and audio prompts greatly facilitates navigation through these various steps in the vehicle identification and product selection process. For example, it is presently contemplated that actual images of vehicles can be displayed to enhance the level of confidence of the consumer in the selection (by confirming that the selected vehicle is similar to the consumer's vehicle). Similarly, images of the recommended product or products may be displayed to familiarize the user with the products, such that these can be more easily located and selected for purchase. The audio prompts may allow for guiding the user through one or more subsequent steps, and may follow various common or preferred paths through the system. Alternatives, or options for selections may also be announced by audio prompts.

The system may also add considerable utility insomuch as diagnosis of problems with vehicles, devices, products and the like may be offered at the same display and as part of the same user experience. For example, in the embodiment illustrated in FIG. 3, if the user enters the informational path indicated by reference numeral 62, various questions, prompts, displays, and audio and/or video may be provided for identifying and diagnosing various symptoms and problems that may be experienced, as indicated at reference numeral 84. In particular, recommendations and tips may be provided based upon access to database information relating to these diagnosed symptoms as indicated by reference numeral 86. In particular, it may be extremely useful for consumers to understand typical symptoms that may be occurring, and products available in the retail establishment for remedying these problems. The system may, of course, loop back to product selection based upon the results, recommendations, and tips.

Reference numeral 88 generally indicates that end of the interactive stage of the system. The interaction may lead, however, to various terminal steps, such as information regarding where to find the products (e.g., batteries), ordering of the products, and so forth. The terminal steps may further direct the user to additional information, such as retail establishment websites, online selection tools, store service information, general information, and so forth, as indicated by reference numeral 90. Furthermore, as indicated by reference numeral 92, some or all of the textual and audio information provided may be offered in multiple languages, such as in English and Spanish. However, depending upon the demographics of the establishment and the neighboring community, any range of languages may be facilitated.

It should be noted that through all of the various stages of the interactive process, access would be made to information stored in the system itself or in other data repositories accessible by the system. For example, the various graphics and displays, as well as audio prompts may be stored locally and played for the user as the process follows through the various stages. Where information is not available locally on the system, it may be accessed through external databases and processing capabilities, and used at least partially to populate the displayed information in real time.

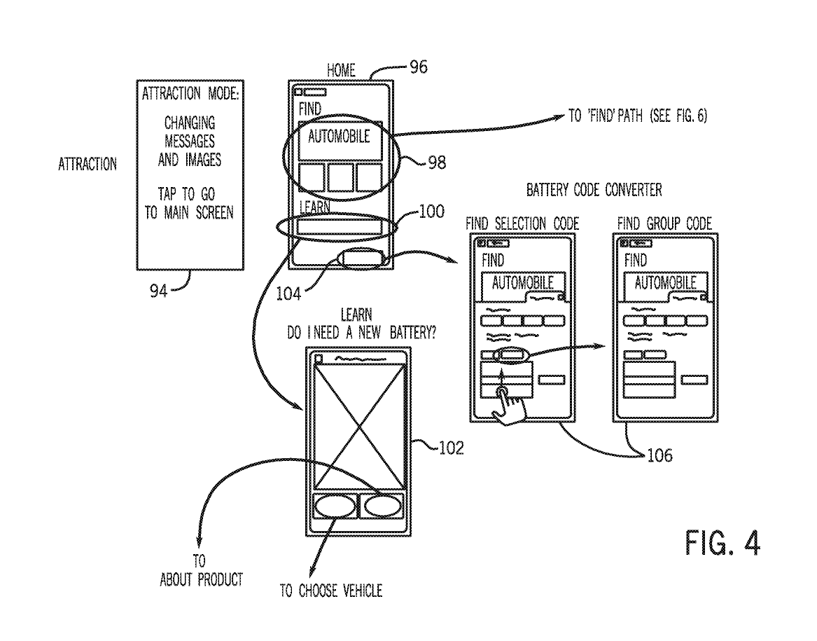

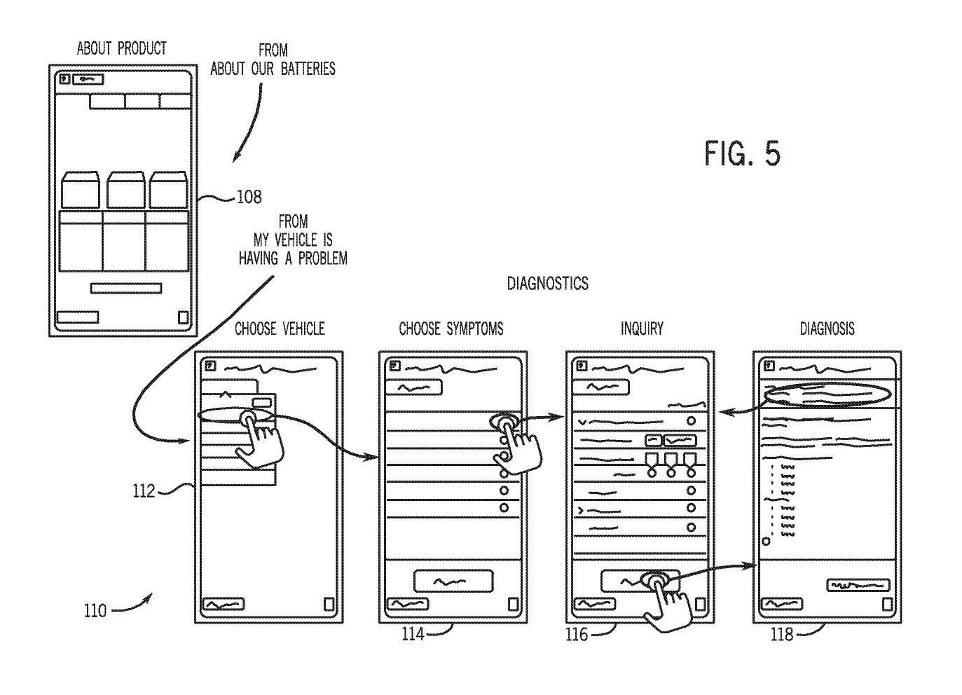

FIG. 4 illustrates certain preliminary user viewable displays that may be employed for initiation of the interactive process. As indicated at reference numeral 94, this may begin with an attraction display, which may include graphics, video and audio output, and so forth. The purpose of the attraction mode is generally to draw the user to the system and to facilitate initiation of the interactive process. The home screen 96 discussed above, in the illustrated embodiment, allows the user to enter into a “find” path by selection of certain on-screen locations as indicated by reference numeral 98. The user may also select to enter into an informational path as indicated by reference numeral 100. Finally, in the illustrated embodiment the home screen allows for selection of a code entry path as indicated by reference numeral 104. When the code entry path is selected, the user may be shown one or more entry displays 106 with graphics and interface tools for selecting a product (e.g., battery) code. In many establishments, it may be preferred that the user refer to product codes unique to the retail establishment. The code selector or converter allows for conversion of various codes, such as from particular manufacturers, or generic codes, to store codes. As described more fully below, if the user enters into the information path, various displays may be provided as indicated by reference numeral 102. These may allow the user, for example, to learn about products, such as batteries, to learn about how to diagnose problems with products, to locate the products in their vehicles, to remove or install products, and so forth.

As noted above, the system may advantageously provide for diagnostics that allow users to identify certain symptoms or problems that are being experienced, and that may resolved through selection and purchase of one or more products. Accordingly, a product line display 108 may be provided, such as to allow users to view images of various products (e.g., batteries), their characteristics, the specifics for their utilization, and so forth. The diagnostics displays, designated generally and collectively by reference numeral 110, may include a series of informational, input, and diagnosis displays. In the illustrated embodiment, a vehicle selector 112 allows a user to input information regarding the particular vehicle in which a problem is being experienced. A subsequent display 114 allows the user to identify or select various symptoms that are being experienced. Based upon these selections, then, a local or remote database is consulted to identify and summarize the inquiry as indicated by display 116. Once the inquiry is complete, a search is made of the one or more databases to identify a diagnosis that may be displayed, as indicated by reference numeral 118. Interaction between these displays may allow the user to hone in on particular problems, and the displays may send the user to additional information, product recommendations, and so forth.

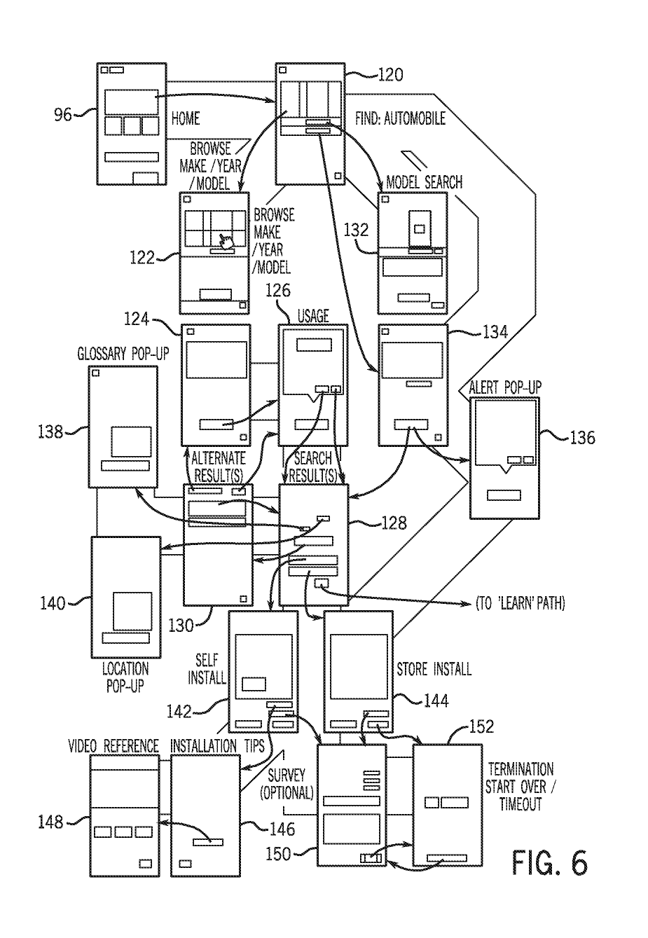

FIG. 6 illustrates various stages and displays through a “find” path designed to identify a device or system, such as a particular vehicle, and a product, such as a battery, that is recommended for the vehicle. The process may begin with the home screen 96. As noted above, from this screen several paths are possible. In a first path, the user initiates a vehicle identification search via a display 120. The display 120 may allow for input of various information regarding the vehicle, and may lead to a browse-type display 122 where the user is prompted to input the make, year, and model of the vehicle. Ultimately, a completed search display is provided as indicated by reference numeral 124 based upon the selection and consultation of the one or more databases that serve the system. In a presently contemplated embodiment, as illustrated below, an actual image of the vehicle is offered in this screen to enhance the confidence of the user in the identification and selection process. The user may also be prompted to input usage data for the vehicle as indicated by display 126. This usage information may be particularly useful for identifying recommended products, such as where product recommendations may vary based on climate, driving conditions, vehicle age, anticipated duration over which the vehicle will be kept, and so forth. Based upon this information, the system provides a results display 128 where one or more products are recommended. Here again, as discussed below, an actual image is preferably provided to facilitate selection by the user and to enhance the user confidence in the recommendation process. The user may also be allowed to search for alternatives to the recommended result and these may be displayed on a separate display as indicated by reference numeral 130.

In the illustrated embodiment, the initiation display 120 may be alternatively followed by a simple model search as indicated by display 132. In such searches, the user may be prompted to identify a vehicle or product (e.g., battery) by model. A completed display 34 may then be provided based upon consultation of one or more databases that support the system, along with an image of the product (e.g., battery). Where necessary, additional displays 136 may be provided, or pop-up inserts may be offered where additional information is required for input.

Other interactive displays and audio prompts may support that system in various ways. For example, in the embodiment illustrated in FIG. 6, a glossary display or pop-up insert may be provided to defined certain terms, clarify usage of certain terms, and so forth. These may be displayed, for example, based upon user selection, hovering over certain areas of a display, and the like. Such glossary feedback, again, enhances the user experience and adds to the comfort level of the user in product selection and purchase. Similar displays or pop-up inserts may be provided for locations, such as for locations of particular recommended products in the retail establishment. These may be searched by the user and easily identified by reference to the images (or maps) provided in the displays. As noted above, other features may include information for self-installation of the products as indicated by display 142, or information on installation offered by the retail establishment, as indicated by reference numeral 144. Where desired, additional displays and interactive information may be provided, for example, relating to installation tips as indicated by display 146. These tips may lead, ultimately, to one or more informational videos that can be played for the user. In the illustrated embodiment, other displays may include optional survey displays that may prompt the user to evaluate performance of the system. Termination displays 152 may be further provided where the process is terminated, or that prompt the user to go back to certain stages or to start over.

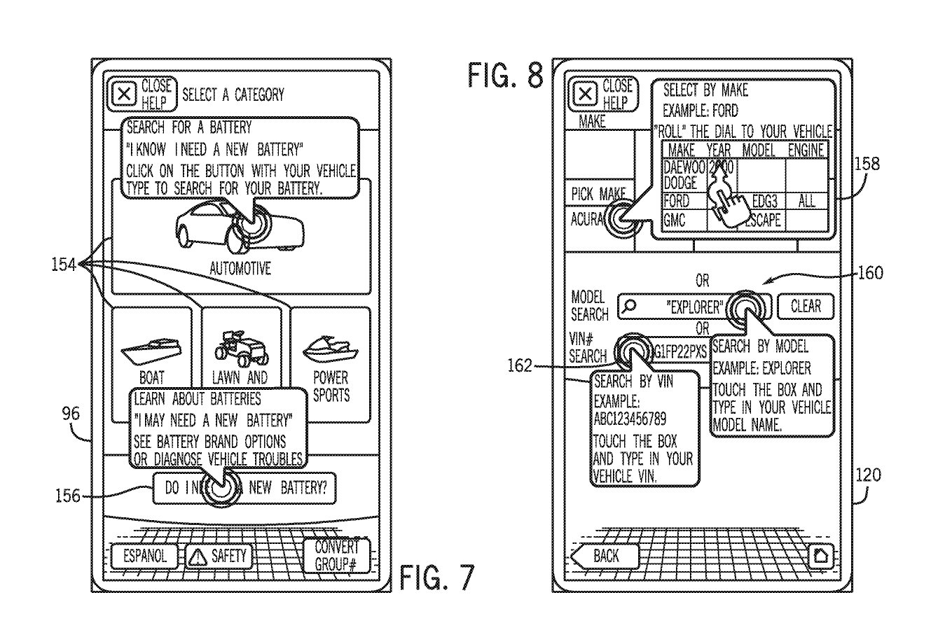

FIGS. 7-21 illustrate certain presently contemplated displays of the type described above that greatly enhance the utility of the system for the identification of devices, such as vehicles, and products, such as automotive batteries. Certain of these displays are illustrated with pop-up inserts that may appear based upon selection or hovering over certain regions of the displays with an input device, the user's finger, or any other interactive technique. FIG. 7, for example, illustrates an exemplary home screen 96. Here again, the home screen allows for certain vehicle type selections as indicated by reference numeral 154, and may allow the user to enter into an informational path by information selection 156. It should be noted, here again, that although the illustrated embodiment relates to batteries, any type of component or part may be accommodated in the system. Still further, the system may be adapted to allow for a selection of any range of different parts, for vehicles, and other systems. By way of example, the same system may accommodate the same selection of batteries, tires, engine parts, accessories, and so forth.

FIG. 8 illustrates an exemplary initial vehicle find display 120. In this illustrated embodiment the user may enter the make, year and model selections as indicated by reference numeral 158. Reference numeral 160 illustrates a model search selection where the user may select from one or more pre-programmed models for vehicles. As noted above, such displays may also include a VIN search selection as indicated by reference numeral 162 where such information is accessible to the user.

FIG. 9 illustrates an exemplary make/year/model selection display 122 that may be accessed via the display 120 of FIG. 8. In this embodiment, multiple makes, years and models may be displayed for selection by the user, as indicated by reference numerals 164, 166 and 168, respectively. Where necessary various engines may be displayed and selected by the user as indicated by reference numeral 172. Importantly, the display then consults the one or more databases that supports the system and provides visual feedback in the form of an image of the vehicle as indicated by reference numeral 172.

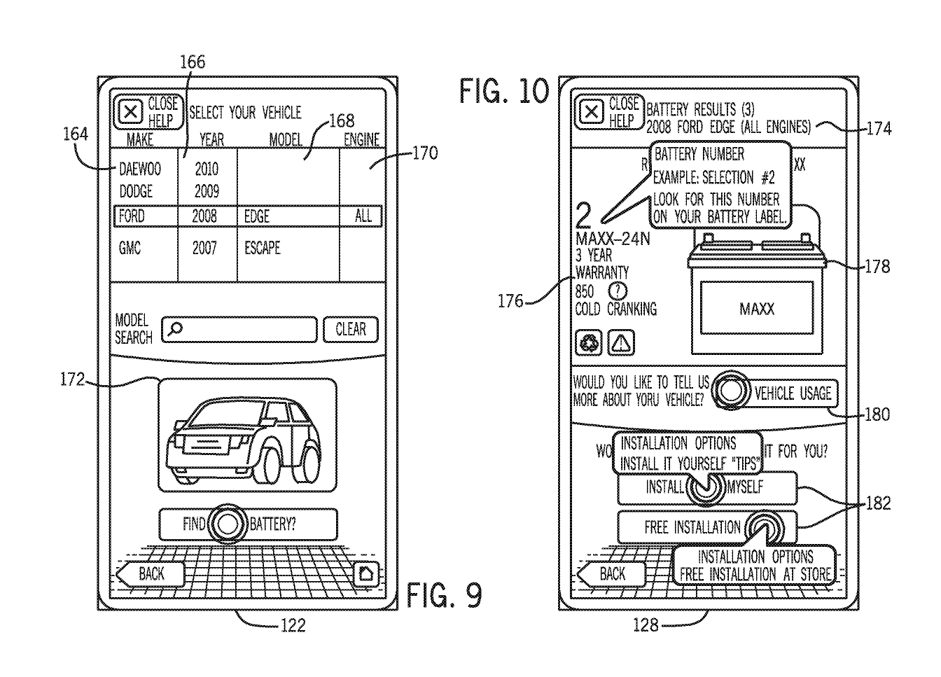

FIG. 10 illustrates an exemplary of search results display 128. As noted above, based upon the various information input by the user into the other displays and input devices, the system will consult one or more databases to identify one or more recommended products. In the display illustrated in FIG. 10, then, vehicle information is provided as indicated at reference numeral 174 to confirm the user's vehicle information. Identification information for the recommended product is also provided as indicated by reference numeral 176, as well as any other supporting information, such as warranty, price, and so forth. Here again, one or more images 178 may be provided that illustrate the particular product recommended. It is believed that providing such images greatly facilitates the physical identification and location of the product by the user, and enhances the comfort level and confidence of the user in obtaining the product for purchase. Reference numeral 180 indicates a prompt through which the user may input vehicle usage information as discussed above. Finally, reference numeral 182 illustrates one or more prompts for additional displays relating to product installation information, tips, videos, and so forth.

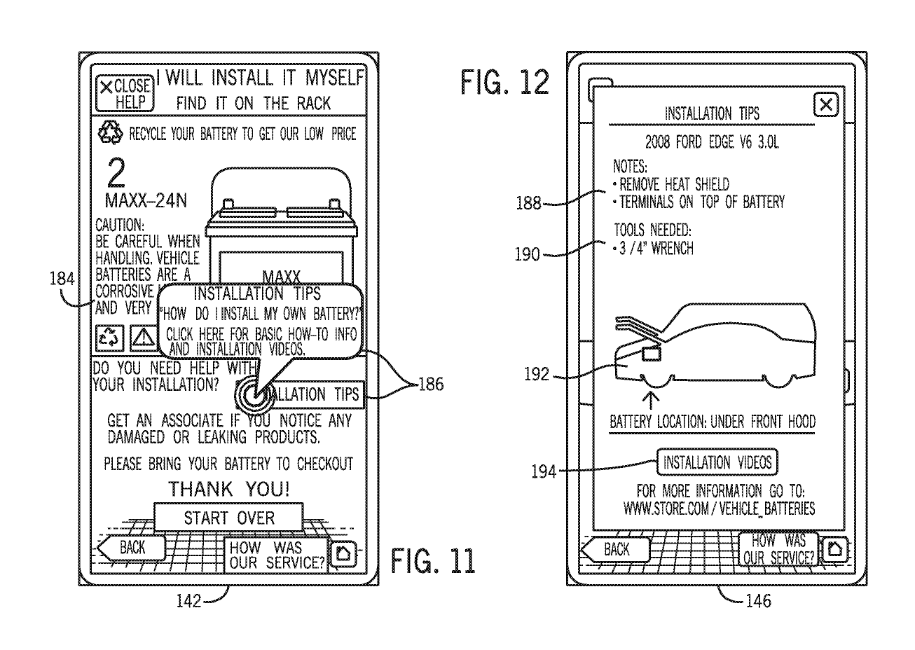

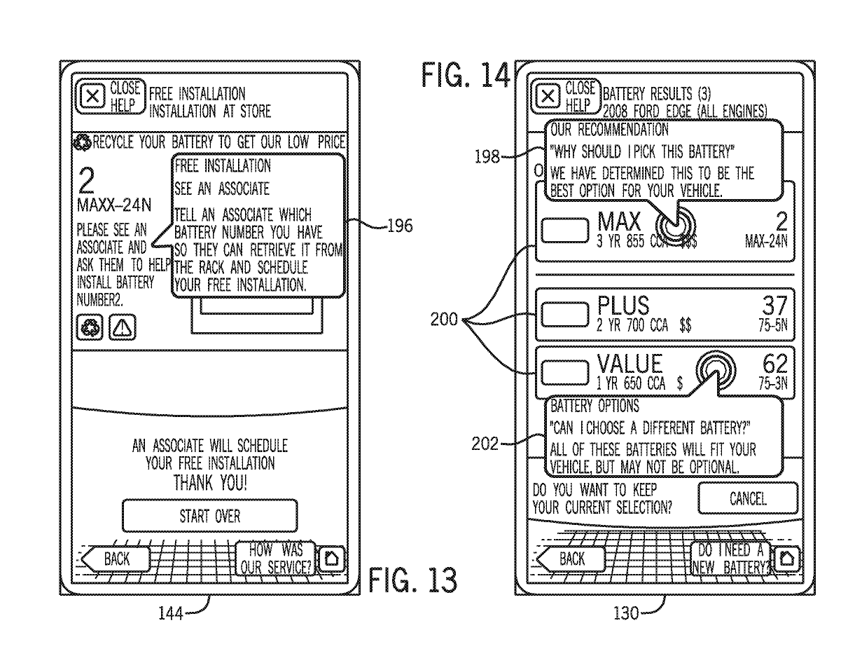

FIG. 11 represents an exemplary self-installation information display. Such displays may be accessed, for example, by selection 182 of the type illustrated in FIG. 10. Once the display is selected, various information relating to installation tips, considerations, and so forth may be displayed as indicated by reference numeral 184. Additional prompts or pop-up inserts may be displayed as indicated by reference numeral 186 that lead to additional displays, such as that of FIG. 12. The installation tips display 146 of FIG. 12 may show, for example, notes regarding what the user will find in the vehicle, safety information, steps in removal and replacement of parts, and so forth as indicated at reference numeral 188. The display may also include an indication of various tools that may be required as indicated at reference numeral 190. In certain embodiments, these tools may be offered for sale in the establishment and this may be facilitated by the display. In the illustrated embodiment, the user is also provided with a visual indication, such as an image 192 of the vehicle and the location of the part (e.g., battery) in the vehicle. Further, in the illustrated embodiment one or more installation videos may be accessed by a video selection 194. Where the establishment offers installation, one or more displays may be provided as shown in FIG. 13. Such displays may allow certain availability, scheduling, price and other information to be offered to the user to facilitate purchase and coordinate the installation process.

FIG. 14 illustrates and exemplary display for alternative products. That is, various recommendations may be made in the preceding displays for products offering specific advantages or answering to specific consumer needs as identified by the identification of the vehicle and its usage. However, the user may desire to purchase or at least explore other product selections, such as based on quality, price, warranty, availability, and so forth. The alternative results display 130, for example, may display optional results comparison as indicated at reference numeral 198, as well as a plurality of alternative products that may be purchased and that may function in lieu of the recommended product, as indicated at reference numeral 200. Various pop-up inserts or other graphics may allow for the display of data relating to these various alternatives as indicated at reference numeral 202. Clearly, additional displays may be provided for information relating to the specification of these alternatives, their availability, their performance, and so forth.

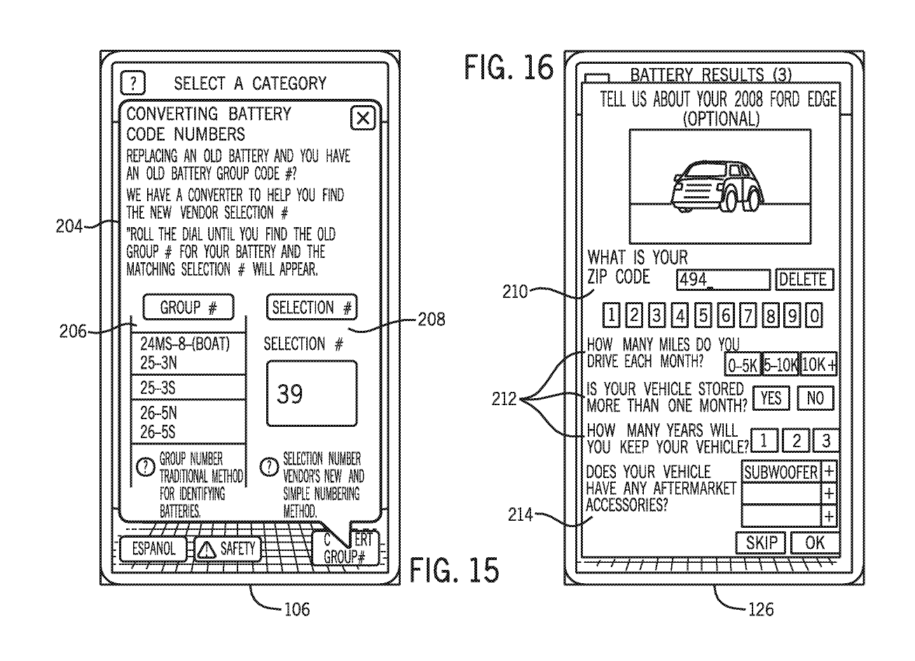

As noted above, certain users may prefer to input directly information relating to an existing part in a vehicle, such as an existing battery. FIG. 15 illustrates an exemplary display for allowing such input and for conversion of codes to store codes where these are different. The code converter display 106, for example, may provide information 104 relating to how to utilize the converter and the type of information and format for the information that may be input. Group number information 206, for example, may be displayed and selected, along with selection number information 208. Where available, such information may allow for rapid identification of available products that replace products currently in the vehicle.

FIG. 16 illustrates an exemplary usage display 126. As described above, the user may desire to input information regarding utilization of the vehicle and this information may enhance the selection of a conforming recommended product or products. In the illustrated embodiment, the display 126 may prompt the user to put certain demographic information, such as location, zip code, and so forth. This demographic information may be collected, along with all of the other information selected or input by users for evaluation of system utilization and analysis of how this utilization may serve to improve store operations, stock, and so forth. Additional information 212 may relate to utilization of the vehicle, and equipment information 214 may be input, relating to other components of the vehicle, particularly components that may influence the selection of the product.

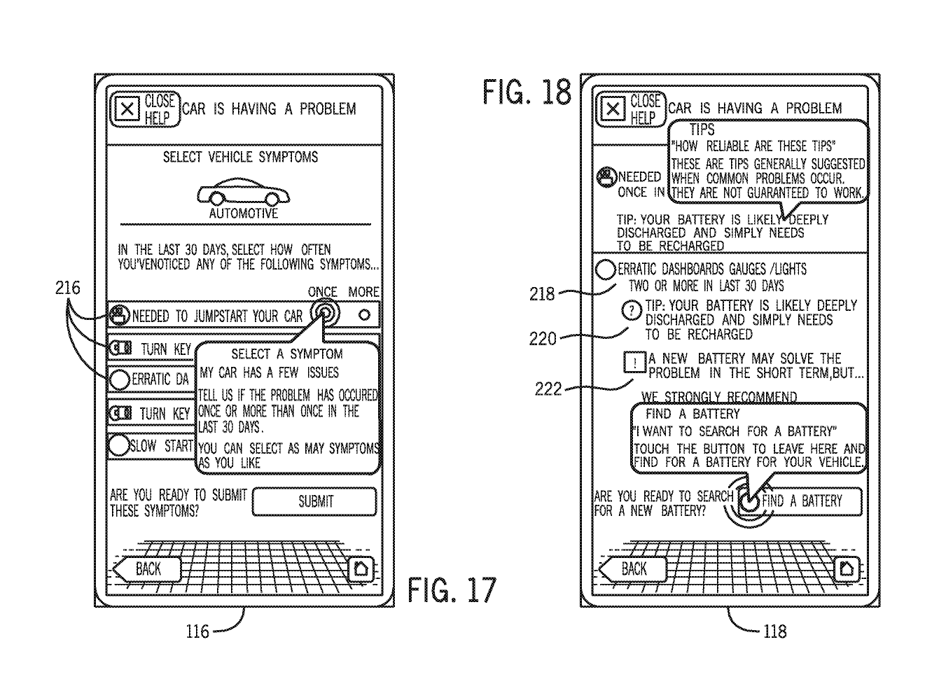

As also noted above, various displays may be provided that enhance the user experience and may be used as a basis for product recommendations. FIGS. 17 and 18, for example, represent trouble-shooting inquiry displays and diagnostic displays 116 and 118, respectively. The user may, at any point in the process of finding a product, consult such displays to identify certain problems that are being experienced in the vehicle, and ideally to relate these to solutions that may be adopted by selection of an appropriate product. The inquiry screen 116 of FIG. 17, for example, may allow for selection of one or more known symptoms as indicated by reference numeral 216. Based upon these symptoms, which may in appropriate circumstances be layered by vehicle, subsystem, and so forth, possible problems, recommendations and so forth may be extracted from the one or more databases that support the system. In the diagnostic display 118 of FIG. 18, for example, a one or more symptoms 218 may be identified, along with one or more tips 220 for addressing the symptom. Moreover, particular recommendations 222 may be offered that may help in resolving the issue.

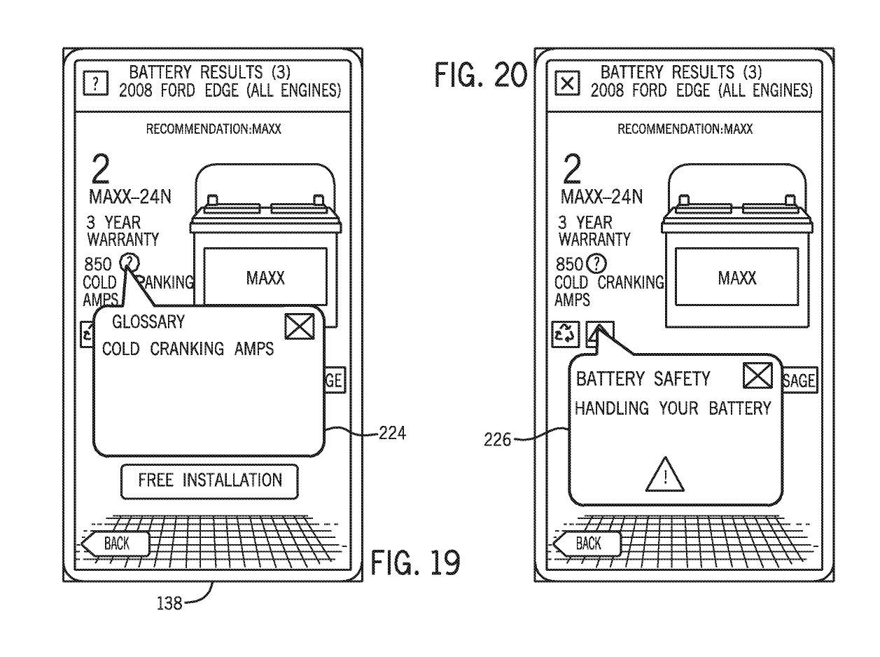

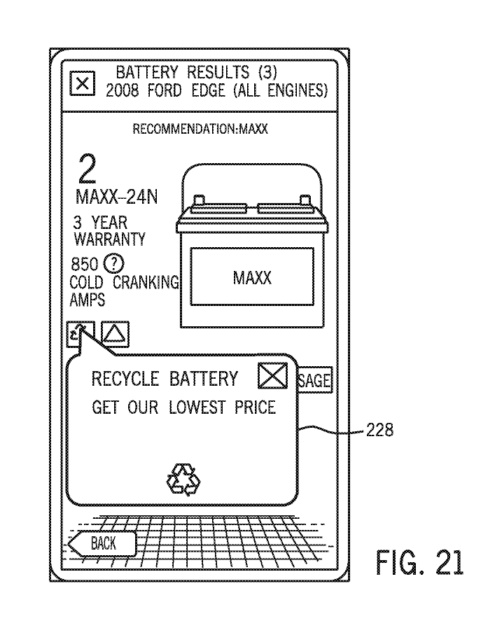

As noted above, various ancillary information may be provided in one or more of the displays, and this may be the subject of a dedicated display or of a pop-up insert in a display. FIG. 19, for example, illustrates a glossary display 138 in which a term of art is defined as indicated by reference numeral 224. Many such pop-up inserts may be provided, where desired, to allow for enhanced customer comfort. FIG. 20 illustrates a further pop-up insert 226 relating to safe handling of the products, particularly, in this case, of batteries. Still further, FIG. 21 illustrates a pop-up insert 228 relating to recycling. In certain context, such as for batteries, a retail establishment may free or for a charge allow for recycling (e.g., collection) products, such as vehicle batteries. Data relating to with these services may be provided on such displays.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1-20. (canceled)

21. A device configured to provide a vehicle battery recommendation to a customer, comprising:
a user interface configured to receive a user input from the customer;
processing circuitry configured to determine, based on an analysis of the user input and data relating to a plurality of vehicle batteries, a selected vehicle battery of the plurality of vehicle batteries; and
a display configured to output the vehicle battery recommendation corresponding to the selected vehicle battery, and to display an image of the selected vehicle battery.

22. The device of claim 21, comprising a screen having the display and the user interface.

23. The device of claim 21, wherein the user interface is configured to receive the user input in response to a prompt of a plurality of prompts accessible by the processing circuitry.

24. The device of claim 23, wherein the plurality of prompts comprises a vehicle type prompt, and wherein the vehicle type prompt includes a vehicle year request, a vehicle make request, a vehicle model request, a vehicle engine request, or any combination thereof.

25. The device of claim 23, wherein the display is configured to display the prompt.

26. The device of claim 23, comprising an audio output configured to output at least a portion of the prompt via audio.

27. The device of claim 23, wherein the plurality of prompts comprises a vehicle usage prompt, and wherein the vehicle usage prompt includes a vehicle age request, a vehicle mileage request, a vehicle condition request, an expected vehicle driving conditions request, an expected vehicle driving climate request, or any combination thereof.

28. The device of claim 23, comprising memory circuitry on which additional data corresponding to the plurality of prompts is stored.

29. The device of claim 21, comprising network circuitry communicatively coupling the processing circuitry with a remote database.

30. The device of claim 29, wherein at least a portion of the data relating to the plurality of vehicle batteries is stored on the remote database.

31. The device of claim 21, comprising memory circuitry on which at least a portion of the data relating to the plurality of vehicle batteries is stored.

32. The device of claim 21, wherein the device is a kiosk configured to be located at a retail establishment.

33. A device configured to provide a vehicle battery recommendation to a customer, comprising:
a user interface configured to receive a user input from the customer;
processing circuitry configured to process the user input and to prepare the vehicle battery recommendation based on a selected vehicle battery from a plurality of vehicle batteries; and
a display configured to output the vehicle battery recommendation corresponding to the selected vehicle battery, and to display an image of the selected vehicle battery.

34. The device of claim 33, comprising network circuitry communicatively coupling the processing circuitry to a remote database, and configured to communicate the selected vehicle battery from the remote database to the processing circuitry.

35. The device of claim 34, wherein the network circuitry is configured to communicate the image of the selected vehicle battery from the remote database to the processing circuitry.

36. The device of claim 33, comprising memory circuitry on which data corresponding to the plurality of vehicle batteries is stored, and on which additional data relating to a plurality of prompts is stored, wherein the display is configured to output a prompt of the plurality of prompts, and wherein the processing circuitry is configured to receive the user input in response to the prompt.

37. The device of claim 36, wherein the prompt corresponds to:
a vehicle type request having a vehicle year request, a vehicle make request, a vehicle model request, a vehicle engine request, or any combination thereof; or
a vehicle usage request having a vehicle age request, a vehicle mileage request, a vehicle condition request, an expected vehicle driving conditions request, an expected vehicle driving climate request, or any combination thereof.

38. The device of claim 33, wherein the processing circuitry is configured to determine, based on an analysis of the user input and data relating to the plurality of vehicle batteries, the selected vehicle battery of the plurality of vehicle batteries.

39. A kiosk configured to provide a vehicle battery recommendation to a customer, comprising:
a screen having a display configured to display a prompt, and having a user interface configured to receive a user input in response to the prompt;
processing circuitry configured to receive the user input and to output, to the display and based on an analysis of the user input and of data corresponding to a plurality of vehicle batteries, the vehicle battery recommendation corresponding to a selected vehicle battery of the plurality of vehicle batteries; and
network circuity communicatively coupling the processing circuitry with a remote database and configured to communicate, to the processing circuitry, at least a portion of the data corresponding to the plurality of vehicle batteries.

40. The kiosk of claim 39, wherein the processing circuitry is configured to select the prompt from a plurality of prompts, and wherein the prompt corresponds to:
a vehicle type request having a vehicle year request, a vehicle make request, a vehicle model request, a vehicle engine request, or any combination thereof; or
a vehicle usage request having a vehicle age request, a vehicle mileage request, a vehicle condition request, an expected vehicle driving conditions request, an expected vehicle driving climate request, or any combination thereof.
